(19) United States
(12) Patent Application Publication
(10) Pub. No.: US 2024/0244339 A1
(43) Pub. Date: Jul. 18, 2024

(54) IMAGING CONTROL DEVICE, IMAGING CONTROL METHOD, AND IMAGING CONTROL PROGRAM

(71) Applicant: FUJIFILM Corporation, Tokyo (JP)

(72) Inventors: Yuta ABE, Saitama-shi (JP); Tetsuro ASHIDA, Saitama-shi (JP); Atsushi ONODA, Saitama-shi (JP); Tomoharu SHIMADA, Saitama-shi (JP); Morito NISEKI, Saitama-shi (JP)

(73) Assignee: FUJIFILM Corporation, Tokyo (JP)

(21) Appl. No.: 18/618,573

(22) Filed: Mar. 27, 2024

Related U.S. Application Data
(63) Continuation of application No. PCT/JP2022/028856, filed on Jul. 27, 2022.

(30) Foreign Application Priority Data
Sep. 30, 2021 (JP) 2021-162016

(51) Int. Cl. H04N 23/90; H04N 23/61; H04N 23/66

(52) U.S. Cl. CPC H04N 23/90; H04N 23/61; H04N 23/66

(57) ABSTRACT

An imaging control device includes: a processor; and a memory, and the processor is configured to control one of a plurality of imaging devices based on first image information related to an image captured in a reference state by one of the plurality of imaging devices and second image information related to an image captured in a non-reference state by one of the plurality of imaging devices.

### CROSS REFERENCE TO RELATED APPLICATION

This is a continuation of International Application No. PCT/JP2022/028856 filed on Jul. 27, 2022, and claims priority from Japanese Patent Application No. 2021-162016 filed on Sep. 30, 2021, the entire disclosures of which are incorporated herein by reference.

### BACKGROUND OF THE INVENTION

### 1. Field of the Invention

The present invention relates to an imaging control device, an imaging control method, and a computer readable medium storing an imaging control program.

### 2. Description of the Related Art

JP2000-083246A discloses a camera control system including a plurality of cameras. The plurality of cameras includes an imaging control means capable of controlling an imaging state. At least one of the imaging control means of the plurality of cameras can be manually controlled from outside of the camera, and the camera control system controls the imaging states of the remaining cameras based on information obtained from the manually controlled camera.

JP2007-327750A discloses a camera position detection method. The camera position detection method uses a plurality of cameras, a panoramic camera, and a data processing device, and obtains a positional relationship of the cameras by captured images from the plurality of cameras and the panoramic camera. Each of the plurality of cameras has a drive mechanism that controls the operation of each camera. The panoramic camera images the plurality of cameras. The data processing device controls the plurality of cameras and the panoramic camera and inputs a captured image of each camera to perform data processing.

JP2006-086671A discloses an imaging device including an imaging target installation region for installing an imaging target and a plurality of capturing devices for imaging different side surfaces of the imaging target. Each of the plurality of capturing devices is disposed on a communication path so as to image the side surfaces of the imaging target from a plurality of directions. In the imaging device, panning, tilting, and focusing are automatically controlled so that when one camera tracks the imaging target, the remaining cameras also track the imaging target.

JP2016-208306A discloses an image processing device that is communicably connected to a plurality of cameras, performs image composition processing on a plurality of captured images acquired from the plurality of cameras, and outputs a panorama composite image. The image processing device includes a reference camera determination unit, an imaging condition acquisition unit, an imaging condition setting unit, and an image composition unit. The reference camera determination unit determines one of the plurality of cameras as a reference camera. The imaging condition acquisition unit acquires an imaging condition related to exposure and white balance set in the reference camera. The imaging condition setting unit transmits a setting command of the imaging condition related to exposure and white balance to the other cameras except for the reference camera among the plurality of cameras based on the imaging condition of the reference camera. The image composition unit performs the image composition processing on the plurality of captured images acquired from the plurality of cameras and outputs the panorama composite image.

JP2005-099164A discloses an automatic imaging system. The automatic imaging system includes an imaging camera, a background storage means, a detection means, an extraction means, and an imaging control means. The imaging camera is installed at a predetermined position and images a subject. The background storage means stores a background image of a range that can be captured by using the imaging camera at the predetermined position. The detection means detects that at least a part of the subject has entered the captured image based on a difference between a captured image obtained by the imaging camera and an image of a portion corresponding to the captured image in the background image stored by the background storage means. The extraction means extracts an imaging target part from the subject detected by the detection means. The imaging control means controls the imaging camera such that the imaging target part of the subject is within a desired range in the captured image of the imaging camera.

### SUMMARY OF THE INVENTION

An imaging control device disclosed herein according to an aspect comprises: a processor, and a memory, wherein the processor controls any of a plurality of imaging devices based on first image information as information related to an image captured in a reference state by any of the plurality of imaging devices and second image information as information related to an image captured in a non-reference state by any of the plurality of imaging devices.

An imaging control device disclosed herein according to an aspect comprises: a processor; and a memory, wherein the processor controls any of a plurality of imaging devices based on first image information as information related to an image captured in a reference state by another imaging device different from the plurality of imaging devices and second image information as information related to an image captured in a non-reference state by the other imaging device.

An imaging control method disclosed herein according to an aspect is an imaging control method of controlling a plurality of imaging devices, the imaging control method comprising controlling any of the plurality of imaging devices based on first image information as information related to an image captured in a reference state by any of the plurality of imaging devices and second image information as information related to an image captured in a non-reference state by any of the plurality of imaging devices.

An imaging control method disclosed herein according to an aspect is an imaging control method of controlling a plurality of imaging devices, the imaging control method comprising controlling any of the plurality of imaging devices based on first image information as information related to an image captured in a reference state by another imaging device different from the plurality of imaging devices and second image information as information related to an image captured in a non-reference state by the other imaging device.

An imaging control program stored in a computer readable medium disclosed herein according to an aspect is an imaging control program that controls a plurality of imaging devices, the imaging control program causing a processor to execute a step of controlling any of the plurality of imaging devices based on first image information as information related to an image captured in a reference state by any of the plurality of imaging devices and second image information as information related to an image captured in a non-reference state by any of the plurality of imaging devices.

An imaging control program stored in a computer readable medium disclosed herein according to an aspect is an imaging control program that controls a plurality of imaging devices, the imaging control program causing a processor to execute a step of controlling any of the plurality of imaging devices based on first image information as information related to an image captured in a reference state by another imaging device different from the plurality of imaging devices and second image information as information related to an image captured in a non-reference state by the other imaging device.

### BRIEF DESCRIPTION OF THE DRAWINGS

FIG. 1 is a diagram showing a schematic configuration of an imaging system 100 including an imaging control device 5 as an embodiment of an imaging control device of the present invention.

FIG. 2 is a schematic diagram showing an example in which the imaging system 100 is applied to an imaging studio.

FIG. 3 is a diagram showing an example of an image based on image information captured by an imaging device 1c in FIG. 2.

FIG. 4 is a diagram showing an example of an image based on image information captured by the imaging device 1c in FIG. 2.

FIG. 5 is a schematic diagram showing an example in which the imaging system 100 is applied to an event venue.

FIG. 6 is a schematic diagram showing a state in which an arrangement pattern of a person H3 is changed in FIG. 5.

### DESCRIPTION OF THE PREFERRED EMBODIMENTS

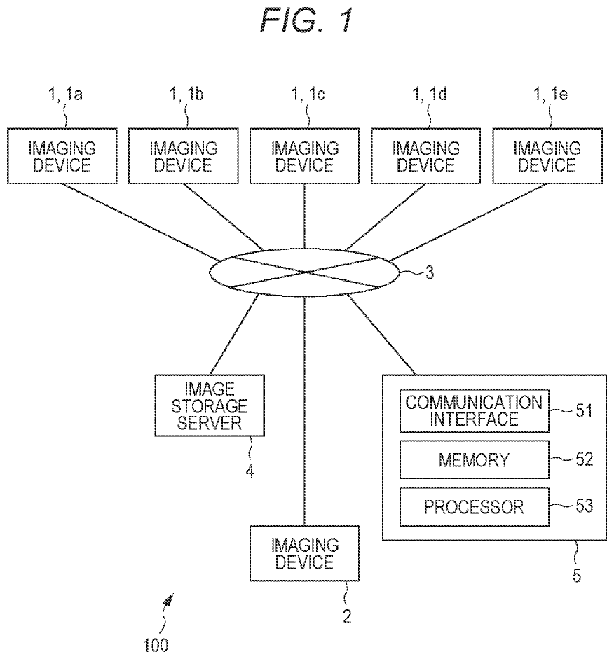

FIG. 1 is a diagram showing a schematic configuration of an imaging system 100 including an imaging control device 5 as an embodiment of an imaging control device of the present invention. The imaging system 100 includes a plurality of imaging devices 1 that images automatically, an imaging device 2 that images by manual operation, a network 3 such as the Internet or a local area network (LAN), an image storage server 4, and an imaging control device 5.

In the example in FIG. 1, the plurality of imaging devices 1 includes five imaging devices which are an imaging device 1a, an imaging device 1b, an imaging device 1c, an imaging device 1d, and an imaging device 1e. The imaging device 2 may be omitted. The imaging device 1 and the imaging device 2 are disposed, for example, in an event venue where an event such as a concert is performed, an imaging studio, or the like. Five imaging devices 1 and the imaging device 2 are disposed at different positions in the same installation place, and are configured to image a subject in the installation place from different directions.

Each of the imaging devices 1 and the imaging device 2 includes an imaging element, an image processing circuit, and a communication interface connectable to the network 3. The image processing circuit generates image data by processing a captured image signal obtained by imaging a subject with the imaging element.

Each of the imaging devices 1 and the imaging device 2 is configured by, for example, a digital camera, a smartphone, or the like. The image data generated by each of the imaging devices 1 and the imaging device 2 and information attached to the image data are also referred to as image information captured by each of the imaging devices 1 and the imaging device 2. The image information generated by each of the imaging devices 1 and the imaging device 2 includes identification information and imaging setting information of the imaging device that generates the image data. In addition, the number of subjects or the type of the subject included in the image can be recognized based on the image information.

The imaging setting information includes an exposure value, an imaging mode, a zoom magnification, an imaging interval in a case where continuous imaging is performed, an imaging direction (pan/tilt angle), and the like. The imaging mode includes a normal mode, a wide dynamic range mode, a plurality of image processing modes, and the like. The normal mode is a mode in which a dynamic range is set as a reference value. The wide dynamic range mode is a mode in which the dynamic range is wider than a reference value. The image processing mode is a mode in which at least one of a color or a gradation in a case of performing image processing is different.

Each of the imaging devices 1 and the imaging device 2 transmits the generated image information to the image storage server 4 via the network 3.

The image storage server 4 includes a processor, a communication interface connectable to the network 3, and a storage device such as a solid state drive (SSD) or a hard disk drive (HDD). The storage device may be a network storage device connected to the network 3. The processor of the image storage server 4 acquires the image information transmitted from the imaging devices 1 and the imaging device 2 and stores the acquired image information in the storage device.

The imaging control device 5 controls the imaging devices 1 based on the image information stored in the storage device of the image storage server 4. A parameter of the imaging devices 1 controlled by the imaging control device 5 includes an imaging condition of the imaging device 1. The imaging condition includes at least one of an imaging interval, an angle of view (zoom magnification), an imaging direction (pan/tilt angle), an exposure value, a color, a gradation, a dynamic range, or an imaging mode. The imaging mode includes single shooting, continuous shooting, an electronic shutter, an electronic front curtain shutter, a mechanical shutter, and the like. As an example, a personal computer, a smartphone, a tablet terminal, or the like is used as the imaging control device 5.

The imaging control device 5 includes a communication interface 51 for connecting to the network 3, a memory 52 including a random access memory (RAM) and a read only memory (ROM), and a processor 53.

The processor 53 is a central processing unit (CPU), a programmable logic device (PLD), a dedicated electric circuit, or the like. The CPU is a general-purpose processor that performs various functions by executing software (program). The PLD is a processor capable of changing a circuit configuration after manufacturing of a field programmable gate array (FPGA) or the like. The dedicated electric circuit is a processor having a circuit configuration designed exclusively for executing specific processing, such as an application specific integrated circuit (ASIC).

The processor 53 may be configured by one processor, or may be configured by a combination of two or more processors of the same type or different types. For example, the processor 53 may be configured by a plurality of FPGAs or a combination of a CPU and an FPGA.

Specifically, a hardware structure of the processor 53 is an electric circuit (circuitry) obtained by combining circuit elements such as semiconductor elements. The processor 53 may perform control or the like for displaying image information stored in the image storage server 4 on a display (not shown), in addition to imaging control described below.

Next, the control performed by the processor 53 of the imaging control device 5 will be described by giving a specific application example of the imaging system 100.

### <First Application Example of Imaging System>

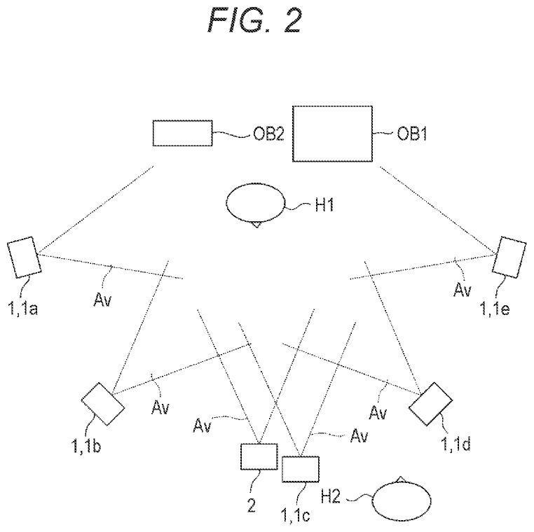

FIG. 2 is a schematic diagram showing an example in which the imaging system 100 is applied to an imaging studio. The five imaging devices 1 and the imaging device 2 constituting the imaging system 100 are installed in the imaging studio. Hereinafter, a main subject to be imaged in the imaging studio and a background subject constituting a background of the main subject are each defined as a specific subject. In other words, the specific subject is a subject to be imaged. In addition, a subject that can be imaged other than the specific subject existing in the imaging studio is defined as a non-specific subject. The main subject includes a person, an animal, a robot, and the like.

The imaging studio includes a person H1, an object OB1, an object OB2, a person H2, a camera operator (not shown), and various equipment (not shown). The person H1 is a specific subject. The object OB1 and the object OB2 are imaging sets, and are disposed behind the person H1. The object OB1 and the object OB2 are also specific subjects. The person H2 adjusts clothes or hair of the person H1. The person H2, the camera operator, the equipment, and the like constitute non-specific subjects.

The five imaging devices 1 image the person H1 from different directions. FIG. 2 shows an imaging region Av of each of the imaging devices 1 and the imaging device 2. Each imaging region Av includes the person H1, the object OB1, and the object OB2. The imaging device 2 is disposed in front of the person H1. The imaging device 2 is manually operated by the camera operator. Each of the five imaging devices 1 automatically and continuously executes imaging under the control of the imaging control device 5.

The processor 53 controls the imaging condition of any of the five imaging devices 1 based on information (first image information) related to a first image captured in a reference state and information (second image information) related to a second image captured in a non-reference state by any of the five imaging devices 1. The reference state is a state in which a predetermined condition is satisfied.

In a first application example, a state in which only the specific subject of the specific subject or the non-specific subject is included in the angle of view (in other words, the imaging region Av) of each imaging device 1 is defined as the reference state. That is, the predetermined condition means a state in which only the subject to be imaged is included in the angles of view of all the imaging devices 1. In the reference state, when the camera operator inputs information indicating that imaging is to be started to the imaging control device 5, the processor 53 issues an imaging start instruction to each of the five imaging devices 1 to cause the imaging devices 1 to start automatic continuous imaging. The continuous imaging is performed by setting the imaging mode, the imaging interval, the exposure value, the zoom magnification, and the imaging direction to predetermined reference values.

It can be said that the reference state is a state in which imaging of only the specific subject of the specific subject or the non-specific subject is started. In other words, the reference state is a state indicated by image information obtained from the imaging devices 1 at an imaging start timing (first timing) of the imaging devices 1. That is, the reference state is a state understood by the image information captured first by each imaging device 1.

The image information captured first by each imaging device 1 is registered in the image storage server 4, and then, the processor 53 registers any one of the five pieces of image information captured first as the first image information captured in the reference state by the imaging device 1. Here, the first image information means an image (image information) captured first by one imaging device set by a user. In other words, the first image information is image information obtained from any one imaging device among the information related to the image captured by each imaging device 1 at the first timing. In the following description, it is assumed that image information first captured by the imaging device 1c is registered as the first image information.

The processor 53 may cause each imaging device 1 to start automatic imaging by each imaging device 1 in response to an operation of the shutter button of the imaging device 2 by the cameraman to issue an imaging instruction or an autofocus instruction to the imaging device 2.

The first image information is registered, the processor 53 performs recognition processing of a subject included in image data of the first image information. Here, three specific subjects of the person H1, the object OB1, and the object OB2 are recognized by the recognition processing.

In the first application example, among pieces of image information sequentially captured by the imaging device 1c, information except for image information captured first (that is, the first image information) is referred to as second image information. After the automatic imaging by the imaging device 1 is started, the camera operator or the person H2 can enter the imaging region Av of the imaging device 1, or equipment may enter the imaging region Av of the imaging device 1 due to movement or the like of the equipment. A state after the start of the imaging of the specific subject as described above, that is, a state in which the subject imaged by the imaging device 1 may change is defined as a non-reference state. In other words, the non-reference state is a state indicated by the image information obtained from the imaging device 1 at a timing (second timing) after the first timing.

The second image information is image information captured by the imaging device 1c in the non-reference state. The processor 53 sequentially acquires the second image information from the image storage server 4, and controls the imaging condition of each imaging device 1 based on the acquired second image information and first image information. In other words, the processor 53 controls the imaging condition of each imaging device 1 based on the information related to the image obtained from any one imaging device 1 at the first timing and the information related to the image obtained from any one imaging device 1 at the second timing.

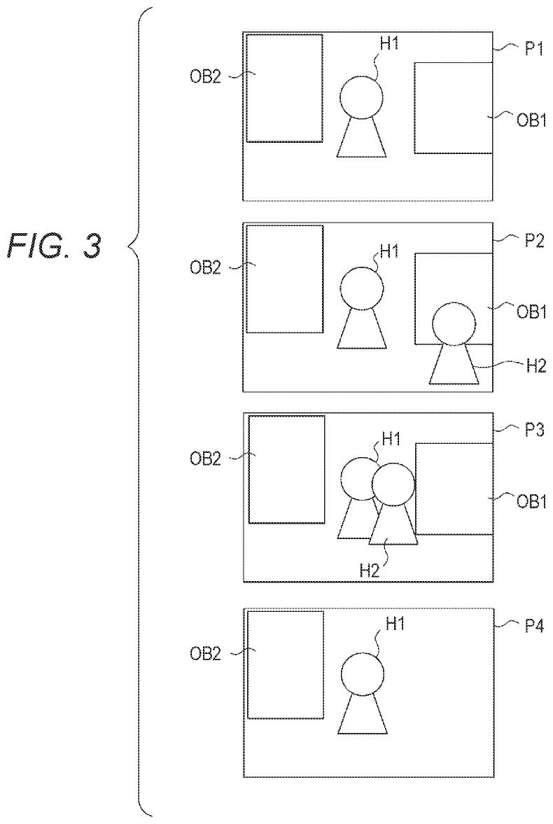

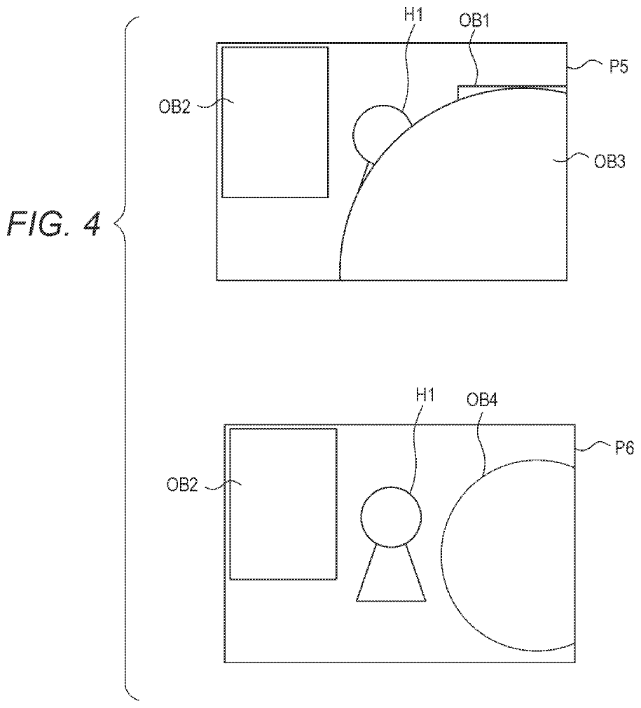

Hereinafter, specific control contents will be described with reference to FIGS. 3 and 4. FIG. 3 exemplifies an image P1 based on the first image information, and an image P2, an image P3, and an image P4 based on the second image information. The image P1 includes the person H1, the object OB1, and the object OB2. As described above, the person H1, the object OB1, and the object OB2 are all the specific subjects.

The image P2 and the image P3 include the person H2 as a non-specific subject in addition to all the specific subjects included in the image H2. In the image P2, a distance between the persons H1 and H2 is larger than the distance in the image P3. On the other hand, in the image P3, the distance between the person H1 and the person is are smaller than the distance in the image P2.

It is assumed that the image P4 is captured while the object OB1 is being changed to another object by the person H2, for example. Accordingly, the image P4 includes only the object OB2 and the person H1.

FIG. 4 exemplifies an image P5 and an image P6 based on the second image information. The image P5 corresponds to an image captured in a state in which a part of the specific subject is shielded by the object OB3 such as equipment. The image P6 corresponds to an image captured in a state in which the object OB1 constituting the background is changed to another object OB4.

### Control Example 1

The processor 53 determines coincidence or non-coincidence of the subject based on the first image information and the second image information, and controls the imaging condition of each imaging device 1 based on the determination result. For example, the processor 53 controls the imaging condition of each imaging device 1 based on the number of subjects included in the image data of the first image information and the number of subjects included in the image data of the second image information. That is, the processor 53 determines coincidence or non-coincidence of the number of subjects, and when the number of subjects does not coincide, the processor 53 controls the imaging condition such that an imaging frequency of each imaging device 1 changes.

Specifically, when the number of subjects recognized from the second image information is larger than the number of subjects recognized from the first image information, the processor 53 sets the imaging interval of each imaging device 1 to be larger than the reference value. When the number of subjects recognized from the second image information is larger than the number of subjects recognized from the first image information, it can be determined that the non-specific subject is to be imaged by each imaging device 1 as in the image P2 or the image P3 shown in FIG. 3. Setting the imaging interval to be larger than the reference value includes stopping the continuous imaging. In this way, in a situation where the non-specific subject is imaged in addition to the specific subject, the imaging condition is controlled such that imaging is performed at a lower frequency than in a situation where only the specific subject is imaged. As a result, it is possible to prevent imaging from being performed more than necessary.

Note that the control of the imaging condition is an example, and other control may be performed. Specifically, in the control, the imaging condition is controlled such that the imaging frequency of each imaging device 1 is reduced when the number of subjects does not coincide. However, the imaging condition may be controlled such that the imaging frequency of each imaging device 1 is increased when the number of subjects does not coincide. For example, in a case where it is desired to acquire more images in which the non-specific subject is captured, the imaging interval may be set to be smaller than the reference value. Similarly, the control of the imaging condition is an example in the following description, and another control may be performed.

When the number of subjects recognized from the second image information is smaller than the number of subjects recognized from the first image information, the processor 53 may determine that the background subject is being changed as in the image P4 shown in FIG. 3, and may set the imaging interval of each imaging device 1 to be larger than the reference value. Since a situation in which the number of subjects to be imaged is reduced is assumed to be a situation in which some preparation is being performed, imaging can be prevented from being performed more than necessary by reducing the imaging frequency in such a situation.

### Control Example 2

When it is determined that the number of subjects does not coincide and it is determined that the number of subjects in the second image information is larger than the number of subjects in the first image information, the processor 53 may control the imaging condition of each imaging device 1 based on the distance to the subject in the second image information.

Specifically, in a case where the number of subjects recognized from the second image information is larger than the number of subjects recognized from the first image information as shown in the image P2 or the image P3, the processor 53 may control the imaging condition of each imaging device 1 based on the distances between the non-specific subjects (the person H2 in the example in FIG. 3) included in the image data of the second image information and the specific subjects (person H1) included in the image data of the second image information.

More specifically, when the processor 53 determines that the number of subjects recognized in the second image information is large, the processor 53 may change the imaging interval based on whether the distance between the specific subject and the non-specific subject included in the second image information is equal to or larger than a predetermined threshold value. The processor 53 may keep the imaging interval at the reference value when the distance is equal to or larger than the threshold value, and may make the imaging interval less than the reference value when the distance is less than the threshold value. The image P2 shows an example in a case where the distance between the specific subject and the non-specific subject is equal to or larger than the threshold value. On the other hand, the image P3 shows an example in a case where the distance between the specific subject and the non-specific subject is less than the threshold value.

The processor 53 may set the imaging interval to be larger than the reference value when the distance is equal to or larger than the threshold value, and may set the imaging interval to be less than the reference value when the distance is less than the threshold value. The situation in which the person H1 and the person H2 are close to each other is considered as a situation in which the person H1 is adjusting the clothes and hair of the person H2. In such a situation, by increasing the imaging frequency, many natural figures of the person H1 which are not imaged by the camera operator can be imaged, and a valuable image can be obtained.

### Control Example 3

When the number of subjects included in the image data of the first image information is the same as the number of subjects included in the image data of the second image information, the processor 53 may change the imaging condition of each imaging device 1 in a case where the subjects do not coincide. In other words, when the number of subjects coincides but identity of the subjects cannot be confirmed, the processor 53 may change the imaging condition of each imaging device 1.

For example, control in a case where the image based on the second image information is the image P6 in FIG. 4 will be described. The number of subjects in the image P6 coincides with the number of subjects in the image P1. On the other hand, the image P6 includes an object OB4 as the non-specific subject instead of the object OB1 as the specific subject. In such a case, the processor 53 changes the imaging condition of each imaging device 1 to an imaging condition suitable for the second image information.

Specifically, the processor 53 changes the exposure value of each imaging device 1 to a value suitable for the object OB2 and the object OB4, changes setting of the color or gradation of each imaging device 1 to a value suitable for the object OB2 and the object OB4, changes the dynamic range of each imaging device 1 to a value suitable for the object OB2 and the object OB4, or changes the angle of view of each imaging device 1 such that the entire object OB1 and the object OB4 are imaged.

In addition, even when the coincidence of the number of subjects and the identity of the subjects can be confirmed, the processor 53 may change the imaging condition of each imaging device 1 based on the positional relationship of the subjects. The positional relationship of the subjects includes a relative positional relationship between the main subject and the background subject, and a positional relationship of the specific subject with respect to the angle of view.

Specifically, even when the number of subjects included in the image data of the first image information is the same as the number of subjects included in the image data of the second image information and the subjects coincide, in a case where the position of the background subject is greatly changed, the imaging direction of each imaging device 1 may be changed so that the background subject enters the angle of view.

Furthermore, the processor 53 may change the imaging condition of each imaging device 1 based on color information obtained from the first image information and the second image information regardless of the coincidence of the number of subjects and the identity of the subjects.

Specifically, when the color of the specific subject is changed from the image data of the first image information in the image data of the second image information, the processor 53 may change the imaging condition of each imaging device 1. For example, when an ornament having a vivid color is added to an imaging set as the specific subject, the processor 53 may perform filtering processing of emphasizing color development on the image data to emphasize the color of the ornament. On the other hand, when the color of the imaging set is weakened, the processor 53 may perform filtering processing of obtaining a black and white image on the image data.

The processor 53 may change the imaging condition of each imaging device 1 when brightness of the specific subject of the first image information and brightness of the second image information do not coincide. In other words, when the brightness of the specific subject is changed from the image data of the first image information in the image data of the second image information, the imaging condition of each imaging device 1 may be changed. For example, when a light that emits strong light is added to the imaging set as the specific subject, the imaging condition may be changed such that each imaging device 1 performs high dynamic range (HDR) imaging.

In addition, when the imaging set is moved, the processor 53 may change the imaging direction of each imaging device 1 in accordance with the movement of the imaging set. Along with the change of the imaging direction, when the specific subject is further changed as described above, the imaging condition may be controlled in a similar manner to the above. In other words, when the imaging set is moved and the light is added to the imaging set, the processor 53 may change the imaging condition of each imaging device 1 to perform the HDR imaging in addition to the change of the imaging direction.

### Control Example 4

When at least a part of the specific subject is blocked by the non-specific subject in the image data of the second image information, the processor 53 may set the imaging interval of each imaging device 1 to be larger than the reference value. For example, in the example of the image P5 in FIG. 4, a part of the person H1 is blocked by the object OB3. In such a case, by setting the imaging interval of each imaging device 1 to be larger than the reference value, it is possible to prevent many images in which the specific subject is hidden from being imaged.

Note that the imaging device that changes the imaging condition may be some of the plurality of imaging devices. For example, when at least a part of the specific subject imaged by some imaging devices of the plurality of imaging devices 1 is blocked by the non-specific subject and the specific subject imaged by the other imaging devices is not blocked by the non-specific subject, only the imaging interval of some imaging devices may be set to be larger than the reference value and the imaging interval of the other imaging devices may be set to be the same as or shorter than the reference value. When the imaging intervals of the other imaging devices are set to be shorter than the reference value, it is possible to cover a decrease in the total imaging number of some imaging devices in which the imaging intervals are set to be larger than the reference value.

Alternatively, when at least a part of the specific subject is blocked by the non-specific subject (object OB3), the processor 53 may change the angle of view. For example, the processor 53 may control the imaging device 1 to zoom out the non-specific subject so as to reduce the size of the non-specific subject in the image. The angle of view may be changed instead of changing the imaging interval or in addition to changing the imaging interval.

In the above description, the image information captured first by the imaging device 1c is set as the first image information, and the image information captured by the imaging device 1c after the first image information is obtained is set as the second image information. In addition, the processor 53 controls the imaging condition of each of the five imaging devices 1 based on the first image information and the second image information. In other words, in the above description, the processor 53 controls the imaging condition of all the imaging devices 1 included in the imaging system 100 based on the first image information and the second image information obtained by one imaging device 1c.

However, the processor 53 may control the imaging condition of each of the four imaging devices 1 other than the imaging device 1c based on the first image information and the second image information. That is, the imaging device 1c may be used as a dedicated device that acquires the first image information and the second image information, and the processor 53 may control each of the imaging device 1a, the imaging device 1b, the imaging device 1d, and the imaging device 1e based on the first image information and the second image information. In this manner, the imaging condition of the imaging device 1c is not changed from initial setting, and the imaging conditions of the other imaging devices 1a, 1b, 1d, and 1e are changed in accordance with the situation of an imaging site based on the first image information and the second image information. That is, since the specific subject is imaged by the five imaging devices 1 under two types of imaging conditions, various image data can be obtained.

In addition, control may be performed such that each of the imaging device 1a, the imaging device 1b, the imaging device 1d, and the imaging device 1e does not perform imaging under the same imaging condition. That is, the processor 53 may control the imaging condition of at least one of the imaging device 1a, the imaging device 1b, the imaging device 1d, or the imaging device 1e based on the first image information and the second image information. Accordingly, more various image data can be obtained.

When the imaging device 1c is used as a dedicated device that acquires the first image information and the second image information, and the imaging device 1c operates in a mode of automatically setting the imaging condition of the imaging device 1c, the processor 53 may control the imaging condition of at least one of the imaging device 1a, the imaging device 1b, the imaging device 1d, or the imaging device 1e based on a difference between the imaging setting information included in the first image information and the imaging setting information included in the second image information.

For example, when the brightness of the specific subject at the time of imaging the first image information is different from the brightness of the specific subject at the time of imaging the second image information, the imaging condition of the imaging device 1c is automatically changed in accordance with a difference in the brightness. Accordingly, there is a difference between the imaging setting information (exposure value) included in the first image information and the imaging setting information (exposure value) included in the second image information. In a case where the difference is equal to or larger than a threshold value, the processor 53 performs control to bring at least one imaging condition (for example, an exposure value) of the imaging device 1a, the imaging device 1b, the imaging device 1d, or the imaging device 1e close to the imaging setting information (for example, the exposure value) included in the second image information. In this manner, imaging suitable for the brightness of the specific subject can be performed by the imaging device 1a, the imaging device 1b, the imaging device 1d, and the imaging device 1e.

In the above description, the image information captured first by the imaging device 1 is registered as the first image information. However, the image information captured first by the imaging device 2 may be registered as the first image information.

In addition, the first image information and the second image information are captured by the same imaging device 1 (imaging device 1c), but this configuration is no necessary. For example, image information captured first by the imaging device 1c may be used as the first image information, image information captured later by the imaging device 1b may be used as the second image information, and the processor 53 may control at least one of the five imaging devices 1 based on the first image information and the second image information.

As described above, in the first application example, the imaging condition of the imaging device 1 can be automatically changed based on the second image information imaged by the imaging device 1 and the first image information captured by the imaging device 1 or the imaging device 2. Therefore, the imaging condition can be changed in real time with a change in the subject being imaged, and imaging can be performed optimally according to the state of the subject.

### <Second Application Example of Imaging System>

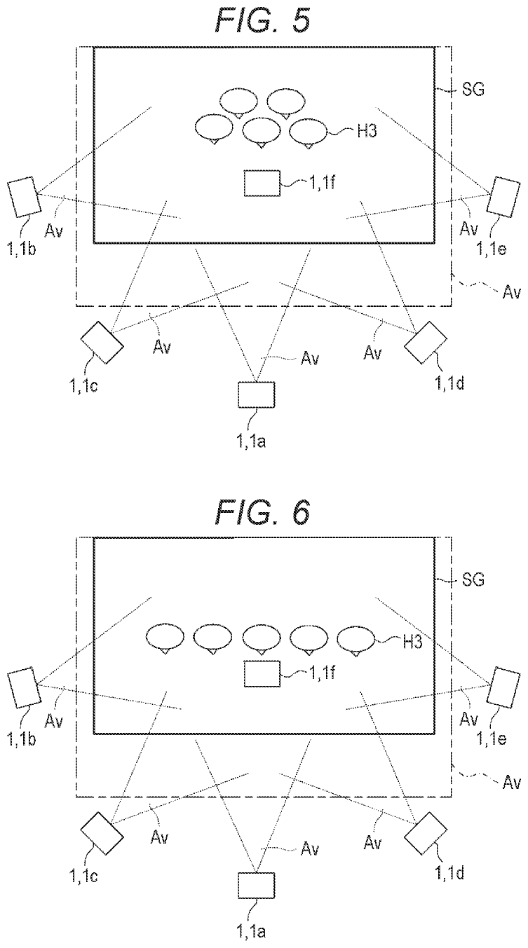

FIGS. 5 and 6 are schematic diagrams showing an example in which the imaging system 100 is applied to the event venue where a concert is held. In a second application example, in the imaging system 100, the imaging device 2 is deleted, and an imaging device 1f is added instead. The imaging device 1f is an imaging device that automatically and continuously performs imaging under the control of the imaging control device 5. Six imaging devices 1 constituting the imaging system 100 are installed in the event venue where a group of five persons H3 gives a concert.

The six imaging devices 1 are disposed around a stage SG, and image the group playing on the stage SG from different directions. FIG. 5 shows the imaging region Av of each imaging device 1. The five persons H3 are included in each of the imaging regions Av.

The imaging device 1f is installed at a position higher in a vertical direction than the imaging device 1a, the imaging device 1b, the imaging device 1c, the imaging device 1d, and the imaging device 1e. The imaging device 1f is configured to be capable of imaging substantially the entire region of the stage SG. That is, the imaging region Av of the imaging device 1f overlaps a part or a whole of the imaging region Av of at least one of the imaging device 1a, the imaging device 1b, the imaging device 1c, the imaging device 1d, or the imaging device 1e. The imaging region Av of the imaging device 1f constitutes an inclusive imaging region. That is, the inclusive imaging region means an imaging region including at least a part of the imaging region Av of the plurality of imaging devices 1a to 1e. In other words, the inclusive imaging region includes a whole of the imaging region Av of at least one imaging device or a part of the imaging region Av of at least one imaging device among the imaging devices 1a to 1e.

The imaging device 1f is an imaging device that images the stage SG in a bird's-eye view. The 1f of the imaging device may be a flying object such as a drone. The imaging device 1f may be a device that is attached near a ceiling of the stage SG and is movable in a horizontal direction and a plane direction.

Each of the six imaging devices 1 automatically and continuously executes imaging under the control of the imaging control device 5. In general, in an imaging device, even when the same region is imaged, a difference occurs in an obtained image depending on a type of a lens, a type of an imaging element, and a configuration of an image processing engine or the like. The six imaging devices 1 may be imaging devices having the same configuration, or may be imaging devices having imaging characteristics different from those of the imaging device 1f which images in a bird's-eye view. In other words, in the configurations of the lens, the imaging element, the image processing engine, and the like, the six imaging devices 1 may be the same, or only the imaging device 1f may be different.

In the second application example, the processor 53 controls each of the imaging device 1a, the imaging device 1b, the imaging device 1c, the imaging device 1d, and the imaging device 1e based on the first image information captured in the reference state by the imaging device 1f and the second image information captured in the non-reference state by the imaging device 1f.

In the second application example, the reference state and the non-reference state are determined based on a schedule of the event. Specifically, the reference state is a state in which rehearsal of a concert is being conducted, and the non-reference state is a state in which actual performance of a concert is being conducted. In other words, the reference state is a state indicated by the image information captured by the imaging device 1f during the rehearsal. The rehearsal is the first timing. The non-reference state is a state indicated by image information captured by the imaging device 1f during actual performance. The actual performance is a timing (the second timing) after the first timing.

At a concert, the five persons H3 stand still in various arrangement patterns. For example, FIG. 5 shows an arrangement pattern in which the five persons H3 are gathered at the center of the stage SG and stand still side by side in two rows. FIG. 6 shows an arrangement pattern in which the five persons H3 stand still side by side in a line on the stage SG. Here, during the concert, it is assumed that the arrangement pattern of the group is scheduled to transition to the arrangement pattern shown in FIG. 6 after becoming the arrangement pattern shown in FIG. 5.

In starting the rehearsal of the concert, when a staff inputs information indicating that the rehearsal is to be started to the imaging control device 5, the processor 53 issues an imaging start instruction to at least the imaging device 1f among the six imaging devices 1. Accordingly, the processor 53 causes the imaging device 1f to start automatic continuous imaging. Here, the continuous imaging is imaging in which the imaging mode, the imaging interval, the exposure value, the zoom magnification, and the imaging direction are set to predetermined reference values.

The processor 53 acquires image information captured at a timing immediately before the arrangement pattern of the group significantly changes among the image information captured during the rehearsal, and registers the acquired image information as the first image information. As described above, in this embodiment, it is determined by the schedule that the arrangement pattern greatly changes from the arrangement pattern shown in FIG. 5 to the arrangement pattern shown in FIG. 6. Therefore, the processor 53 acquires the image information captured by the imaging device 1f in a state of the arrangement pattern shown in FIG. 5 and registers the acquired image information as the first image information. The first image information is captured in a state in which a subject (person H3) having a predetermined arrangement pattern is included in an angle of view during rehearsal.

When there are many large changes in the arrangement pattern, the processor 53 registers a plurality of pieces of image information as the first image information. In other words, the number of pieces of first image information varies depending on the number and types of predetermined arrangement patterns.

When the actual performance of the concert is started, the staff inputs information indicating that the actual performance is started to the imaging control device 5. When the input of the information indicating the start of the actual performance is detected, the processor 53 issues an imaging start instruction to the six imaging devices 1 to cause the imaging devices 1 to start automatic continuous imaging. Here, the continuous imaging is imaging in which the imaging mode, the imaging interval, the exposure value, the zoom magnification, and the imaging direction are set to predetermined reference values.

In the second application example, image information sequentially captured by the imaging device 1f during the actual performance is referred to as the second image information. After each of the imaging devices 1 starts automatic imaging, the processor 53 sequentially acquires the second image information captured by the imaging device 1f, and controls the imaging condition of each of the other five imaging devices 1 except for the imaging device 1f based on the acquired second image information and the registered first image information.

Specifically, the processor 53 controls the imaging condition of each of the other five imaging devices 1 except for the imaging device 1f based on the arrangement pattern of the group included in the first image information and the arrangement pattern of the group included in the second image information.

For example, the processor 53 derives similarity between the arrangement pattern of the group included in the second image information and the arrangement pattern of the group included in the first image information, maintains the imaging condition of each of the five imaging devices 1 at the reference value the similarity is less than a threshold value, and changes the imaging condition of each of the five imaging devices 1 from the reference value when the similarity is equal to or larger than the threshold value.

In the arrangement pattern shown in FIG. 6, the five persons H3 can be individually imaged. Therefore, when an arrangement pattern similar to the arrangement pattern shown in FIG. 5 is included in the second image information, the processor 53 changes the imaging mode of each of the five imaging devices 1 to an imaging mode suitable for individual imaging. Alternatively, the processor 53 changes a focus position or the zoom magnification of each of the five imaging devices 1 so that each of the five persons H3 can be imaged in close-up. The imaging mode suitable for the individual imaging includes, for example, a portrait mode, a skin-beautifying mode, and the like.

Alternatively, when an arrangement pattern similar to the arrangement pattern shown in FIG. 5 is included in the second image information, the processor 53 may control the zoom magnification of the imaging device 1 such that all of the five persons H3 are imaged in the arrangement pattern shown in FIG. 6.

When the arrangement pattern as shown in FIG. 6 is obtained, or when the subject continuously takes the same pose or the like, the scene is often important in the event. In order to increase the number of captured images in a time zone including such an important scene, the processor 53 may set the imaging device 1 to the continuous imaging mode when an arrangement pattern similar to the arrangement pattern shown in FIG. 5 is included in the second image information. The processor 53 may set the imaging device 1 to the continuous imaging mode when an arrangement pattern similar to an arrangement pattern immediately before the subject continuously takes the same pose is included in the second image information.

Alternatively, the processor 53 may control the imaging condition such that imaging timings of the plurality of imaging devices 1 are the same in the scene of the arrangement pattern as shown in FIG. 6. The processor 53 may control the imaging condition such that the imaging timings of the respective imaging devices 1 are slightly different from each other. When the imaging timings of the plurality of imaging devices 1 are the same, it is possible to obtain images captured at the same time from various angles in a scene of interest.

A timing at which the movement of the subject is fast may be determined based on a difference between a plurality of pieces of first image information captured during the rehearsal. In this case, when the similarity between the arrangement pattern of the group included in the first image information immediately before the movement of the subject becomes fast and the arrangement pattern of the group included in the second image information (for example, FIG. 5) is equal to or larger than a threshold value, the imaging condition may be controlled such that the plurality of imaging devices 1 use a mechanical shutter. Such control can prevent rolling distortion in the use of a rolling shutter.

In the above description, the processor 53 controls the imaging condition of each of the five imaging devices 1 except for the imaging device 1f based on the first image information and the second image information. However, the processor 53 may control the imaging condition of at least one imaging device of the imaging device 1a, the imaging device 1b, the imaging device 1c, the imaging device 1d, or the imaging device 1e based on the first image information and the second image information. In this manner, imaging of the group is performed under a plurality of types of imaging conditions by the imaging device 1a, the imaging device 1b, the imaging device 1c, the imaging device 1d, and the imaging device 1e. As a result, various image data can be obtained.

In addition, the processor 53 may control only the imaging condition of the imaging device among the imaging device 1a, the imaging device 1b, the imaging device 1c, the imaging device 1d, or the imaging device 1e in which the imaging region overlaps a part or a whole of the imaging region Av of the imaging device 1f. For example, it is also considered that the imaging direction, the angle of view, and the like of the imaging devices 1a to 1f are changed in the middle of the imaging. In this case, the imaging region Av of any of the imaging device 1a, the imaging device 1b, the imaging device 1c, the imaging device 1d, or the imaging device 1e may possibly not overlap the imaging region Av of the imaging device 1f. In this case, it is desirable not to control an imaging device that images an imaging region Av that does not overlap the imaging region Av of the imaging device 1f. The information related to the imaging device in which the imaging region Av does not overlap the imaging region Av of the imaging device 1f may be registered in advance by the user or may be determined using the image recognition processing.

The imaging device 1f that captures each of the first image information and the second image information may be configured to automatically change the imaging setting such as the exposure value during actual performance in accordance with imaging environment. In this case, the processor 53 may change the imaging setting (for example, the exposure) of the five imaging devices 1 other than the imaging device 1f based on the second image information.

For example, the processor 53 changes the imaging setting (for example, the exposure value) of the five imaging devices 1 based on a difference between the imaging setting information (for example, the exposure value) included in the second image information and the imaging setting information (for example, the exposure value) included in each image information captured by the five imaging devices 1 other than the imaging device 1f. Specifically, the processor 53 changes the exposure of the five imaging devices 1 such that the exposure values of the five imaging devices 1 other than the imaging device 1f approach the exposure value of the imaging device 1f. In this manner, the event can be imaged with appropriate exposure by the six imaging devices 1.

The imaging device that captures each of the first image information and the second image information may be configured to automatically change the imaging setting such as the exposure value according to the imaging environment based on the schedule of the event. For example, the schedule of the event may include a factor for changing the brightness of the imaging environment, such as a display of a video or a change of illumination, in addition to the arrangement pattern described above. In this case, the exposure value of the imaging device 1 may be controlled to be automatically changed in consideration of the schedule of the event.

A particularly notable scene other than the arrangement pattern and the brightness of the imaging environment is determined depending on the schedule of the event in some cases. For example, in a case where the event is a concert, a scene in which performers take the same pose at the same time may be determined by the schedule. In this case, in order to increase the number of captured images in a time zone including the scene of the same pose being taken based on the schedule, the imaging device 1 may be set to the continuous imaging mode for several seconds before and after the scene of the same pose being taken. In a case where the event is a wedding ceremony, the imaging device 1 may be set to the continuous imaging mode also in a scene in which a bride or a groom enters.

The imaging timings of the plurality of imaging devices 1 in a specific scene may be controlled to be the same based on the schedule, or the imaging timings of the plurality of imaging devices 1 may be controlled to be slightly different. When a time zone in which the movement of the subject is fast is known based on the schedule, the mechanical shutter may be controlled to be preferentially used only in the time zone.

As described above, according to the second application example, the imaging condition of the five imaging devices 1 other than the imaging device 1f can be automatically changed based on the second image information captured by the imaging device 1f and the first image information captured by the imaging device 1f. Therefore, the imaging condition can be changed in real time with a change in the subject being imaged, and imaging can be performed optimally according to the state of the subject.

Note that the processor 53 may further change the imaging condition of the imaging device 1f based on the first image information and the second image information captured by the imaging device 1f. For example, it is assumed that a performance in which the illumination of the stage SG becomes brighter is done after the arrangement pattern shown in FIG. 5 is changed to the arrangement pattern shown in FIG. 6.

In such a case, the processor 53 first determines whether the similarity between the arrangement pattern of the group included in the second image information and the arrangement pattern of the group included in the first image information is equal to or larger than a threshold value. Here, when the similarity is equal to or larger than the threshold value, the processor 53 changes the imaging condition of each of the imaging device 1a, the imaging device 1b, the imaging device 1c, the imaging device 1d, and the imaging device 1e from the reference value. Further, the processor 53 changes the exposure value of the imaging device 1f in consideration of the change in the brightness of the subsequent stage SG.

In this manner, the second image information can have high quality, and the processor 53 can control the imaging device 1a, the imaging device 1b, the imaging device 1c, the imaging device 1d, and the imaging device 1e with high accuracy.

As described above, at least the following matters are described in the present specification. Corresponding components and the like in the above-described embodiment are indicated in parentheses, but the present disclosure is not limited thereto.

(1)

An imaging control device (imaging control device 5) comprising:
a processor (processor 53); and
a memory (memory 52),
wherein the processor controls any of a plurality of imaging devices (imaging devices 1) (imaging device 1a, imaging device 1b, imaging device 1c, imaging device 1d, imaging device 1e, or imaging device 1f) based on first image information as information related to an image captured in a reference state by any of the plurality of imaging devices (imaging device 1c or imaging device 1f) and second image information as information related to an image captured in a non-reference state by any of the plurality of imaging devices (imaging device 1c or imaging device 1f).
   (2)

The imaging control device according to (1), wherein the reference state is a state in which a predetermined condition is satisfied.

(3)

The imaging control device according to (1) or (2),
wherein the reference state is a state in which only a specific subject (person H1, object OB1, and object OB2) is included in an angle of view.
   (4)

The imaging control device according to (3),
wherein the processor controls any one of the plurality of imaging devices based on the number of subjects included in the first image information and the number of subjects included in the second image information.
   (5)

The imaging control device according to (4),
wherein the processor further controls any of the plurality of imaging devices based on a distance between the subjects included in the second image information.
   (6)

The imaging control device according to (3),
wherein the processor controls any of the plurality of imaging devices based on the specific subject included in the first image information and a subject (object OB3) other than the specific subject included in the second image information.
   (7)

The imaging control device according to any of (1) to (6),
wherein the plurality of imaging devices are installed in an imaging studio,
the reference state is a state in which imaging of only a specific subject (person H1, object OB1, and object OB2) to be imaged is started, and
the non-reference state is a state after the imaging of a specific subject to be imaged is started.
   (8)

The imaging control device according to (2),
wherein the non-reference state includes a state in which a background of a specific subject imaged by the plurality of imaging devices is changed from the reference state.
   (9)

The imaging control device according to (2),
wherein the reference state is a state in which a subject having a predetermined pattern is included in an angle of view.
   (10)

The imaging control device according to (9),
wherein the processor controls any of the plurality of imaging devices based on a pattern of a subject included in the first image information and a pattern of a subject included in the second image information.
   (11)

The imaging control device according to (1), (2), (9), or (10),
wherein the plurality of imaging devices are installed in an event venue,
the reference state is a state in which a rehearsal of an event is being conducted, and
the non-reference state is a state in which an actual performance of the event is being conducted.
   (12)

The imaging control device according to (1),
wherein the plurality of imaging devices image an event performed at a venue, and
the reference state and the non-reference state are determined based on a schedule of the event.
   (13)

The imaging control device according to (1) or (2),
wherein the processor controls any of the plurality of imaging devices based on a difference between imaging setting included in the first image information and imaging setting included in the second image information.
   (14)

The imaging control device according to (1) or (2),
wherein the processor controls, based on a difference between imaging setting of the imaging device that has captured the first image information and the second image information and imaging setting of the other imaging device different from the imaging device, the imaging setting of the other imaging device.
   (15)

The imaging control device according to any one of (1) to (14),
wherein the imaging device that has captured the first image information and the imaging device that has captured the second image information are the same.
   (16)

The imaging control device according to any of (1) to (15),
wherein the imaging device that is controlled based on the first image information and the second image information is different from the imaging device that has captured the first image information and the second image information.
   (17)

The imaging control device according to any one of (1) to (16),
wherein a parameter of the imaging device controlled by the processor includes an imaging condition of the imaging device.
   (18)

The imaging control device according to (17),
wherein the imaging condition includes at least one of an imaging interval, an angle of view, an imaging direction, an exposure, or an imaging mode.
   (19)

The imaging control device according to any of (1) to (18),
wherein the processor causes the plurality of imaging devices to perform imaging based on an operation (imaging instruction or autofocus instruction) related to imaging of a manually operated imaging device (imaging device 2) other than the plurality of imaging devices.
   (20)

The imaging control device according to any one of (1) to (19),
wherein the imaging device (imaging device 1f) that captures the first image information is configured to image imaging regions (imaging region Av) of all the imaging devices except for the imaging device, and
the processor changes imaging setting of the imaging devices other than the imaging device that captures the first image information based on image information captured by the imaging device.
   (21)

An imaging control device comprising:
a processor (processor 53); and
a memory (memory 52),
wherein the processor controls any of a plurality of imaging devices (imaging device 1a, imaging device 1b, imaging device 1c, imaging device 1d, imaging device 1e, or imaging device 1f) based on first image information as information related to an image captured in a reference state by another imaging device (imaging device 1f) different from the plurality of imaging devices and second image information as information related to an image captured in a non-reference state by the other imaging device.
   (22)

The imaging control device according to (21),
wherein the other imaging device images an inclusive imaging region including at least a part of an imaging region of the plurality of imaging devices.
   (23)

The imaging control device according to (21),
wherein the other imaging device is located at a higher position in a vertical direction than the plurality of imaging devices.
   (24)

An imaging control method of controlling a plurality of imaging devices, the imaging control method comprising
controlling any of the plurality of imaging devices based on first image information as information related to an image captured in a reference state by any of the plurality of imaging devices and second image information as information related to an image captured in a non-reference state by any of the plurality of imaging devices.
   (25)

An imaging control method of controlling a plurality of imaging devices, the imaging control method comprising
controlling any of the plurality of imaging devices based on first image information as information related to an image captured in a reference state by another imaging device different from the plurality of imaging devices and second image information as information related to an image captured in a non-reference state by the other imaging device.
   (26)

An imaging control program that controls a plurality of imaging devices, the imaging control program causing a processor to execute
a step of controlling any of the plurality of imaging devices based on first image information as information related to an image captured in a reference state by any of the plurality of imaging devices and second image information as information related to an image captured in a non-reference state by any of the plurality of imaging devices.
   (27)

An imaging control program that controls a plurality of imaging devices, the imaging control program causing a processor to execute
a step of controlling any of the plurality of imaging devices based on first image information as information related to an image captured in a reference state by another imaging device different from the plurality of imaging devices and second image information as information related to an image captured in a non-reference state by the other imaging device.

### EXPLANATION OF REFERENCES

1A, 1B, 1C, 1D, 1E, 1F, 1, 2: imaging device
H1, H2, H3: person
OB1, OB2, OB3, OB4: object
P1, P2, P3, P4, P5, P6: image
3: network
4: image storage server
5: imaging control device
51: communication interface
52: memory
53: processor
100: imaging system

What is claimed is:

1. An imaging control device comprising:
a processor; and
a memory,
wherein the processor is configured to control one of a plurality of imaging devices based on first image information related to an image captured in a reference state by one of the plurality of imaging devices and second image information related to an image captured in a non-reference state by one of the plurality of imaging devices.

2. The imaging control device according to claim 1,
wherein the reference state is a state in which a predetermined condition is satisfied.

3. The imaging control device according to claim 1,
wherein the reference state is a state in which only a specific subject is included in an angle of view.

4. The imaging control device according to claim 3,
wherein the processor is configured to control one of the plurality of imaging devices based on number of subjects included in the first image information and number of subjects included in the second image information.

5. The imaging control device according to claim 4,
wherein the processor is configured to further control one of the plurality of imaging devices based on a distance between the subjects included in the second image information.

6. The imaging control device according to claim 3,
wherein the processor is configured to control one of the plurality of imaging devices based on the specific subject included in the first image information and a subject other than the specific subject included in the second image information.

7. The imaging control device according to claim 1,
wherein the plurality of imaging devices are provided in an imaging studio,
the reference state is a state in which imaging of only a specific subject to be imaged is started, and
the non-reference state is a state after the imaging of the specific subject to be imaged is started.

8. The imaging control device according to claim 2,
wherein the non-reference state includes a state in which a background of a specific subject imaged by the plurality of imaging devices is changed from the reference state.

9. The imaging control device according to claim 2,
wherein the reference state is a state in which a subject having a predetermined pattern is included in an angle of view.

10. The imaging control device according to claim 9,
wherein the processor is configured to control one of the plurality of imaging devices based on a pattern of a subject included in the first image information and a pattern of a subject included in the second image information.

11. The imaging control device according to claim 1,
wherein the plurality of imaging devices are provided in an event venue,
the reference state is a state in which a rehearsal of an event is being conducted, and
the non-reference state is a state in which an actual performance of the event is being conducted.

12. The imaging control device according to claim 1,
wherein the plurality of imaging devices image an event performed at a venue, and
the reference state and the non-reference state are determined based on a schedule of the event.

13. The imaging control device according to claim 1,
wherein the processor is configured to control one of the plurality of imaging devices based on a difference between imaging setting included in the first image information and imaging setting included in the second image information.

14. The imaging control device according to claim 1,
wherein the processor is configured to control, based on a difference between imaging setting of one of the plurality of imaging devices that has captured the first image information and the second image information and imaging setting of other of the plurality of imaging devices than the one of the plurality of imaging device that has captured the first image information and the second image information, the imaging setting of the other of the plurality of imaging devices.

15. The imaging control device according to claim 1,
wherein the imaging device that has captured the first image information and the imaging device that has captured the second image information are same.

16. The imaging control device according to claim 1,
wherein the imaging device that is controlled based on the first image information and the second image information is different from the imaging device that has captured the first image information and the second image information.

17. The imaging control device according to claim 1,
wherein a parameter of the imaging device controlled by the processor includes an imaging condition of the imaging device.

18. The imaging control device according to claim 17,
wherein the imaging condition includes at least one of an imaging interval, an angle of view, an imaging direction, an exposure, or an imaging mode.

19. The imaging control device according to claim 1,
wherein the processor is configured to cause the plurality of imaging devices to perform imaging based on an operation related to imaging of a manually operated imaging device other than the plurality of imaging devices.

20. The imaging control device according to claim 1,
wherein the imaging device that captures the first image information is configured to image imaging regions of all of the plurality of imaging devices except for the imaging device that captures the first image information, and
the processor is configured to change imaging setting of other of the plurality of imaging devices other than the imaging device that captures the first image information based on image information captured by the imaging device that captures the first image information.

21. An imaging control device comprising:
a processor; and
a memory,
wherein the processor is configured to control one of a plurality of imaging devices based on first image information related to an image captured in a reference state by other imaging device different from the plurality of imaging devices and second image information related to an image captured in a non-reference state by the other imaging device.

22. The imaging control device according to claim 21,
wherein the other imaging device images an inclusive imaging region including at least a part of an imaging region of the plurality of imaging devices.

23. The imaging control device according to claim 21,
wherein the other imaging device is located at a higher position in a vertical direction than the plurality of imaging devices.

24. An imaging control method of controlling a plurality of imaging devices, the imaging control method comprising
controlling one of the plurality of imaging devices based on first image information related to an image captured in a reference state by one of the plurality of imaging devices and second image information related to an image captured in a non-reference state by one of the plurality of imaging devices.

25. An imaging control method of controlling a plurality of imaging devices, the imaging control method comprising
controlling one of the plurality of imaging devices based on first image information related to an image captured in a reference state by other imaging device different from the plurality of imaging devices and second image information related to an image captured in a non-reference state by the other imaging device.

26. A non-transitory computer readable medium storing an imaging control program that controls a plurality of imaging devices, the imaging control program causing a processor to execute:
controlling one of the plurality of imaging devices based on first image information related to an image captured in a reference state by one of the plurality of imaging devices and second image information related to an image captured in a non-reference state by one of the plurality of imaging devices.

27. A non-transitory computer readable medium storing an imaging control program that controls a plurality of imaging devices, the imaging control program causing a processor to execute:
controlling one of the plurality of imaging devices based on first image information related to an image captured in a reference state by other imaging device different from the plurality of imaging devices and second image information related to an image captured in a non-reference state by the other imaging device.
